(19) United States
(12) Patent Application Publication
(10) Pub. No.: US 2014/0310099 A1
(43) Pub. Date: Oct. 16, 2014

(54) DEVICE AND SYSTEM FOR SEARCHING, DISPLAYING AND OPERATING WEBSITES AND OTHER ELECTRONIC CONTENT

(71) Applicant: Thomas Publishing Company, New York, NY (US)

(72) Inventors: Scott Emerich, Glen Head, NY (US); Rajan Vohra, Princeton, NY (US)

(73) Assignee: Thomas Publishing Company, New York, NY (US)

(21) Appl. No.: 14/212,566

(22) Filed: Mar. 14, 2014

Related U.S. Application Data
(60) Provisional application No. 61/792,248, filed on Mar. 15, 2013.

(51) Int. Cl. G06F 17/30; G06Q 30/02

(52) U.S. Cl. CPC G06F 17/30864; G06F 17/30554; G06Q 30/0256
USPC 705/14.54; 707/722

(57) ABSTRACT

Disclosed is a system for searching a web based content source and displaying the results. The system includes a display device; a user input device; a data storage device; an application controller; and a plurality of gadgets that search a web based content source by receiving a search query, submitting the search query to a search mechanism adapted to search the web based content source, receiving the result, and displaying the result in an operative window. The system accepts input in the form of a search term from a user via the user input device and passes the search term to the application controller; and the application controller determines which gadgets are to be searched, formulates the search term into a search query appropriate for each gadget to be searched, and passes each search query to its corresponding gadget for searching and display of the results.

This application is based on, and claims priority to, U.S. provision application Ser. No. 61/792,248, filed Mar. 15, 2013, entitled Device and System for Searching, Displaying and Operating Websites and Other Electronic Content.

This patent application is not the result of federally funded research or development.

### FIELD OF THE INVENTION

This invention relates to the general field of searching of pages of formation on the internet.

### BACKGROUND OF THE INVENTION

This invention relates to the general field of searching of pages of information on the internet.

The internet is a world-wide computer network comprising of billions of web pages. Internet users commonly want to search for and review information about a particular topic from multiple sources. For example, a person interested in purchasing an electric motor may want to compare information about electric motors from websites operated by several competing vendors of electric motors or from multiple sources that review or recommend electric motors.

As used in this patent application, as “search term” input forming the basis of a search of web pages or electronic content and may comprise text, generally one or more words. A “search term” may also include a numeric or alphanumeric text string or other form of input (for example, an image or a sound) that may be accepted and processed by the search device. Throughout this application, although the invention may be described in terms of searching websites or web pages, the search and display methods may be employed for searching and displaying any type of searchable, displayable electronic content, including but not limited to web-based content sources such as files or other collections of text, electronic books, and multimedia publications.

Systems are available for searching the Internet. These search systems exist in the form of computers and other devices with the capacity to process and execute instructions, with the computer or other processing device being configured to accept a search term, request a search of web pages or other electronic information based on the search term, receive the result of the search, and display the result of the search. To use such a search system, the user submits a search term and receives from the search system a list of relevant web pages or links to web pages located by the search. In this form of search, the search system leaves the user substantial freedom to choose the search term, but the search system typically allows the user little control over the sites to which a search is applied, often allowing the user the choice of a search with no selection of websites specified, or alternatively allowing the user to search only a single website. Further, in these existing search systems, the search result does not include actual, operable web pages (or operable displays of the content located by the search) but instead contains links to web pages located by the search, along with text or graphics extracted from them. To view the web pages located by the search, the user must then view the web pages one-at-a-time in the browser window by clicking a link in the result lists and having the user's browser display the selected page, or by opening each resulting web page in a new “tab,” or a new browser window. Some prior search systems do permit the user to search several selected websites simultaneously for prices on particular items (to applicant's knowledge, travel services such as airfare or hotel rooms), but the searches accept only structured input (a selection among a menu of choices) and do not permit the user to submit a user-selected, free-form search term for searching across multiple websites.

These prior search systems are useful but limited in that they lack the ability to search multiple sites of the user's choosing for a common search term or the user's choosing through a single action. Nor can the prior search systems display the results of a search of multiple websites on a single-page display of live and operable web pages or other content located by the search.

### SUMMARY OF THE INVENTION

The invention provides a device, system, and method for searching web pages and other electronic information and displaying the results of searches. In preferred embodiments the invention searches multiple websites of the user's choosing for a common search term of the user's choosing through a single action and can display the results of a search of multiple websites on a single-page display showing a plurality of live and operable web pages or other content displays of data located by the search.

### BRIEF DESCRIPTION OF THE DRAWINGS

FIG. 1 is a schematic diagram showing an example search system connected to a network according to an embodiment of the invention.

FIG. 2A is a schematic diagram illustrating a search device according to an embodiment of the invention.

FIG. 2B is a schematic diagram illustrating an example arrangement of a network and web server in an embodiment of the invention.

FIG. 2C is a schematic diagram illustrating a search device comprising a plurality of gadgets according to an embodiment of the invention.

FIG. 2D is a functional block diagram of a gadget executing a search based on a received search query according to an embodiment of the invention.

FIG. 3 is a schematic diagram illustrating an example organization of instructions executed by the application controller according to an embodiment of the invention.

FIGS. 4-7 are a series of schematic layouts of screen shots depicting an example of a display according to the invention under a variety of conditions.

FIG. 8 is functional block diagram illustrating various operations of a briefcase according to an embodiment of the invention.

FIGS. 9-13 are a series of schematic layouts of screen shots depicting examples of a collapsible accordion-style display according to the invention under a variety of conditions

FIG. 14 is a flow diagram depicting a method according to an embodiment of the invention.

FIG. 15 is a flow diagram depicting an example briefcase/gadget display method according to an embodiment of the invention.

FIGS. 16-18 are a series of schematic layouts of screen shots depicting an example of a display according to the invention under a variety of conditions.

### DETAILED DESCRIPTION OF THE INVENTION

Following is a description of devices, systems, and methods for searching, displaying, and operating websites and other electronic content according to the invention.

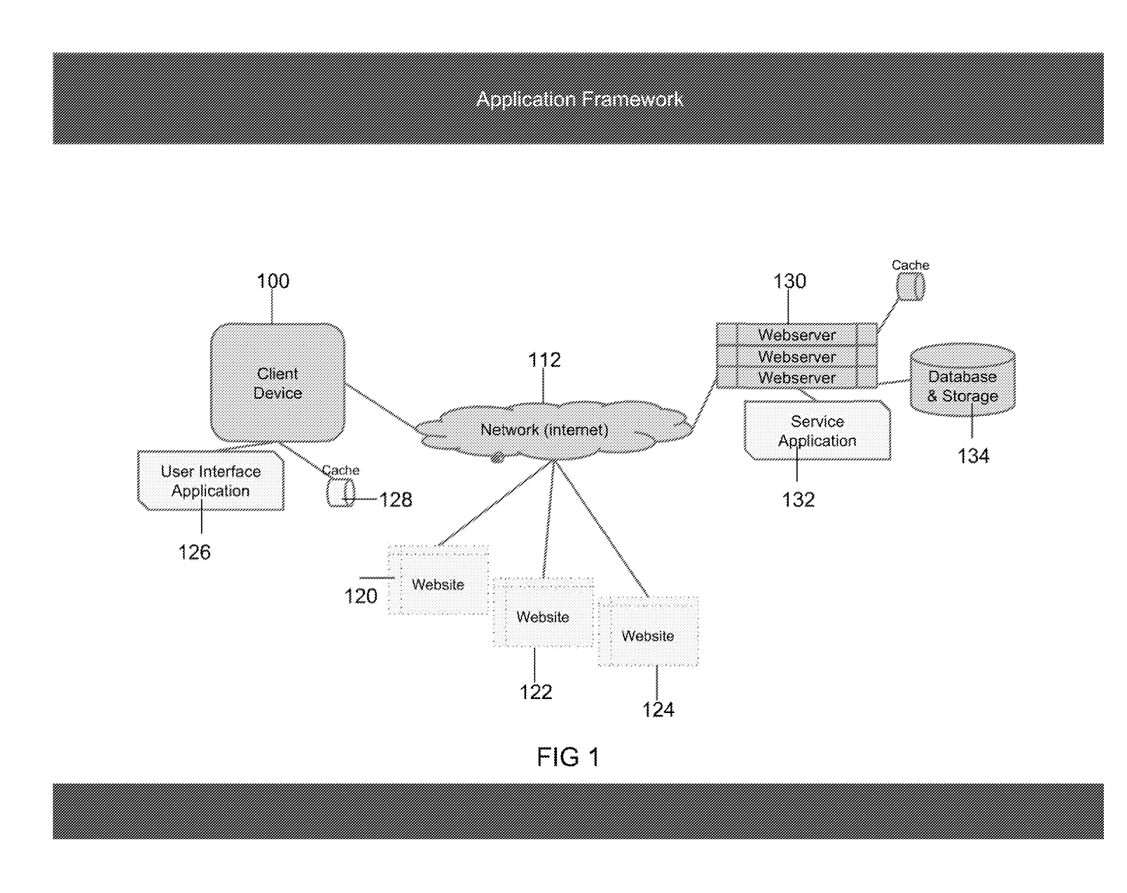

FIG. 1 is a diagram showing a broad overview of an embodiment of the invention. Search device 100 connects to internet 112, which in turn connects to or comprises websites to be searched 120, 122, and 124.

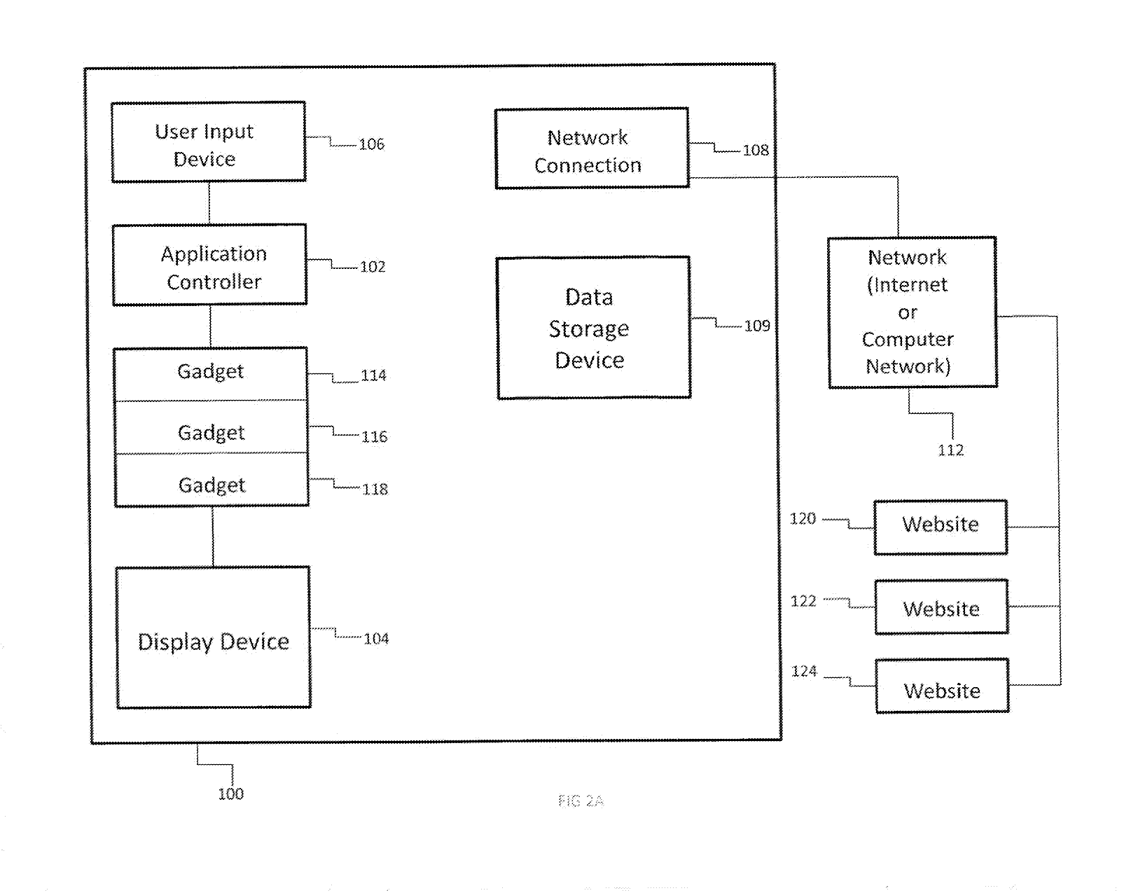

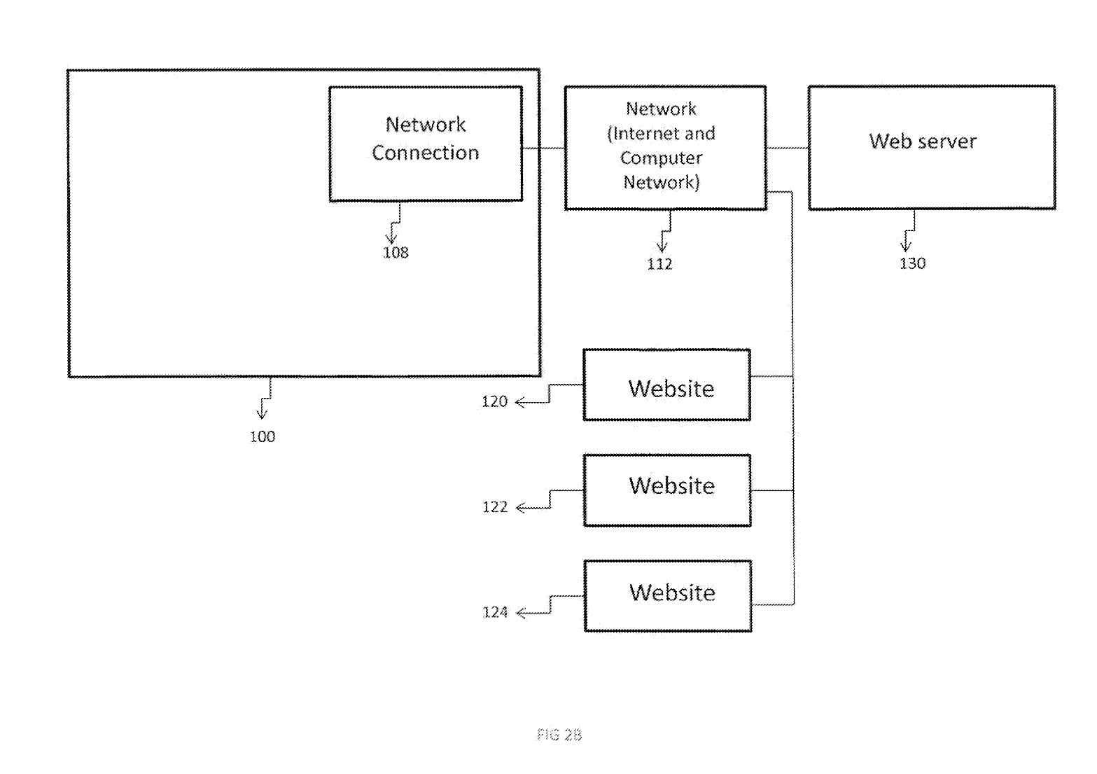

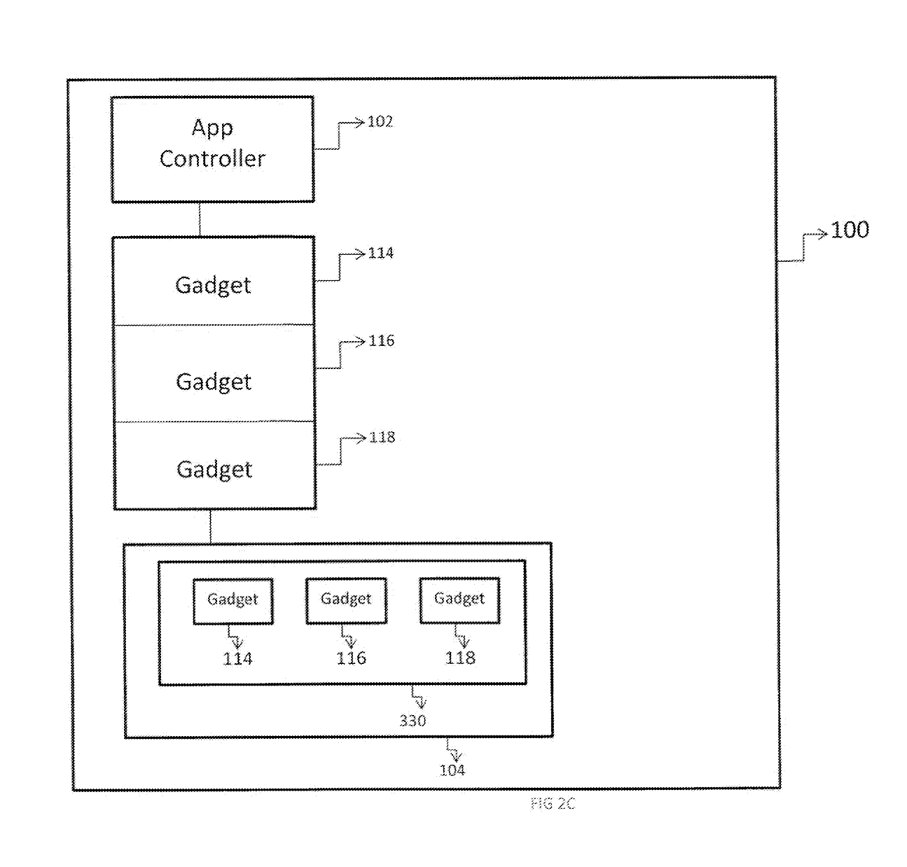

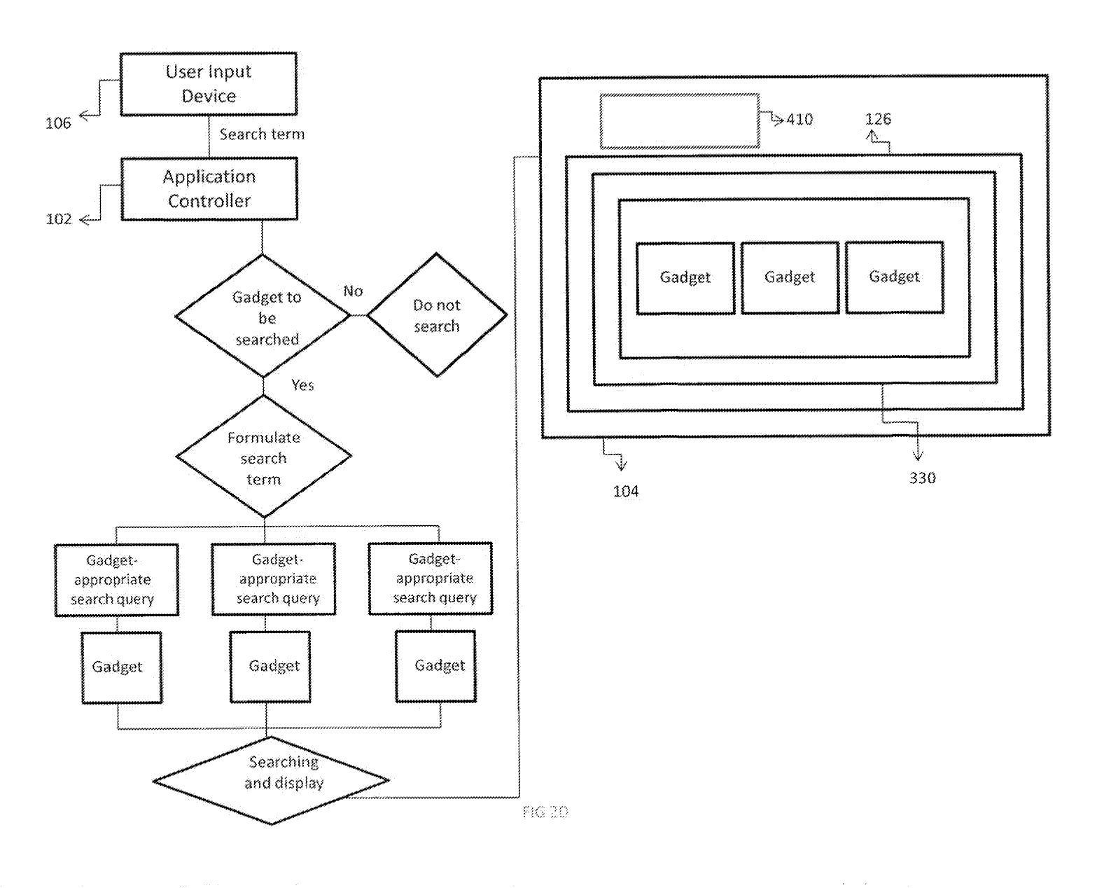

FIG. 2A is a diagram showing a search device according to the invention. The search device includes application controller 102, display device 104, user input device 106, network connection 108, and data storage device 109. Network connection 108 is connected to the network 112, which may be the internet or any other computer network, and which is connected to web based content sourced 120, 122, 124. As shown in FIG. 2B, in one embodiment, network 112 may include or be connected to a web server 130 that serves as a data storage device, providing a database, cache memory, and storage to search device 100.

As shown in FIG. 2C, the search device comprises one or more gadgets, and preferably a plurality of gadgets. A gadget is a device that searches and displays web pages or other electronic content, including content disseminated by an internet service such as web pages (html) or other electronic content (as human-readable standard data like XML, JSON, or non-readable binary data like maps, multimedia, etc.). The processing capacity needed for each gadget may be provided by application controller 102, which may comprise one or more processors capable of executing instructions.

Note that a gadget according to the invention is different from what are sometimes called “gadgets” by others. Others sometimes use the term “gadget” to refer to a small window display of information that is derived from a particular website, but the window is not an actual web page from the website or live, operative window displaying content from the data source. In contrast, a “gadget” according to the invention (and as used in this document) provides a complete or partial display of a web page or other electronic content, with that display being operable and functional such that a user may click any available links, select any available items, scroll the window, shrink or enlarge the view of the website as displayed in the window, or otherwise operate the subject web page or window as desired.

Once a gadget has located and displayed a search result, the gadget appears on a display as a window representation of the website or other electronically delivered content. Displayed gadgets optionally may be sorted and rearranged by drag-and-drop or other convenient method on a display panel 330. A gadget preferably can be expanded in size to display more of the content on the screen as detailed herein. When the size of one displayed gadget is changed, optionally the other displayed gadgets automatically are rearranged to make most efficient use of available space on the display panel 330. Referring to FIG. 2D, a gadget executes a search based on a search query that it receives from the application controller 102.

In an exemplary system according to the invention, the system accepts input in the form of a search term from a user via the user input device 106 and passes the search term to the application controller 102. The application controller 102 determines which gadgets are to be searched, formulates the search term into a search query appropriate for each gadget to be searched, and passes each search query to its corresponding gadget for searching and display of the results. To perform a search, a gadget may perform an http request (via http GET or http POST) to the underlying web content resource with any search parameters populated from the search text box 410. The formatting (configuration) of the request string is determined by the application controller 102 for each gadget based on the characteristics of the search mechanism of the underlying website that corresponds to the gadget. The response from the underlying website is displayed within the window space of the gadget 462 on display panel 330. Display of the gadget window is supported by the IFRAME element of the HTML5 standards at w3c.org iFrame specifications4. 4 W3C.org specifications for iFrame—

The HTML <iframe> Element (or HTML inline frame element) represents a nested browsing context, effectively embedding another HTML page into the current page. In an alternative embodiment, the gadget itself may process the search term into a search query and/or submit the search query to the gadget's corresponding website.

A gadget may be displayed in various shapes and sized, thus allowing the user to easily view, compare and contrast the content of various websites in one screen conveniently. Optionally the gadget will position the underlying content at the most relevant coordinates (for example, the x,y location of the page that provides the material of interest) for content in which the portion of the display of greatest interest is located consistently (for example, below a set of headers or banners). In other words, the underlying page will be shifted (scrolled) so that the most relevant information is visible at the top and left of the gadget window, possibly skipping the left space and top space of the website.

When a gadget is added to the display and there is a search term in the search controller, then the gadget opens within the search context of the display panel 330. In other words, any gadget item that is dropped onto the display panel 330 will automatically perform a keyword search on the underlying website using the search terms in search controller 410 before displaying the response page from the website.

Application controller 102 is a desktop or laptop computer, tablet computer, smart phone, or other device with the capacity to execute instructions and may be a processor that handles other processing in addition to the processing required by the gadget—for example, processing to format search terms entered by a user into a search query to be passed to a gadget.

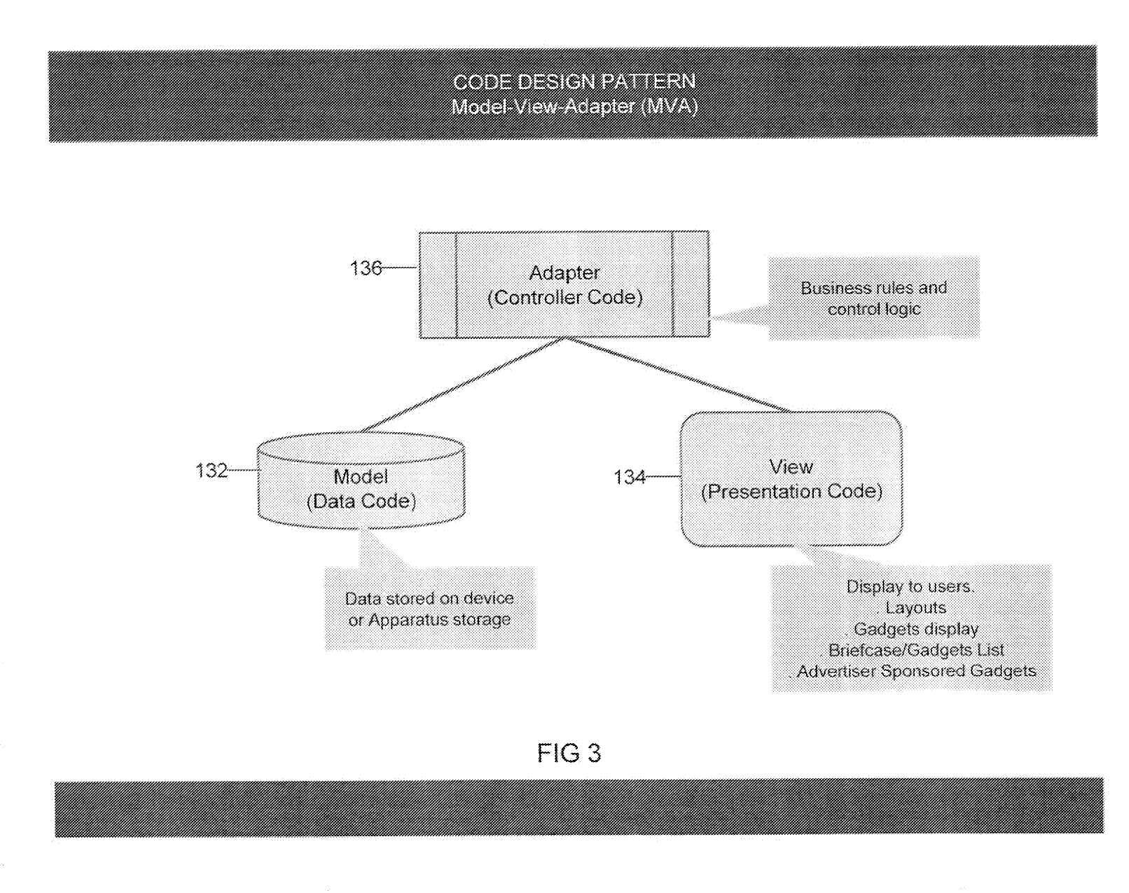

As shown in FIG. 3, optionally the instructions executed by application controller 102 may be organized is the fashion of Model-View-Adapter (MVA) where the Model or Data code (D-code) 132 handles data storage interactions with the underlying SQL or NoSQL database stored in the data storage device which exists in the cloud or natively within Apparatus deployment infrastructure. View or Presentation code (IP-code) 134 handles display of apparatus components and gadget displays. The application controller 102, which comprises a processor running Controller code (C-code) 136, in one embodiment manages business logic, workflow and general rules execution, data retrieval and updates, and updating necessary components, and displaying output via the display device. The work of the application controller 102 may be organized in other ways as well.

Display device 104 may be any of numerous devices capable of displaying visual information, for example, the screen of a desktop or laptop computer, tablet computer, smart phone, or other device. The visual output may be created by the display device using internet browsers (such as IE, Chrome, Sakai, Mozilla, etc.), or native applications or device operating system platforms, or utilizing a third-party middleware technology which acts as go-between for the device operating system and apparatus application code.

User input device 106 may be a keyboard, mouse, touch screen, touch pad, thumb wheel, microphone, or other device capable of receiving input from a user.

Network connection 108 may include any communication device capable of facilitating interaction between a user and one or more web pages or other bodies of electronic information. The network connection may be wired or wireless.

Data storage device 109 is in operative connection with application controller 102 and may comprise hard drives, internal memory, removable memory (SD memory card), third party storage (cloud storage services and other storage devices).

A first computer system may, and preferably does, provide the processor which acts as the application controller 102, as well as providing display device 104, input device 106, and network connection 108 utilized by a particular user. A second computer system may provide the data storage device and processing capacity needed in order to select, operate on, and access stored data.

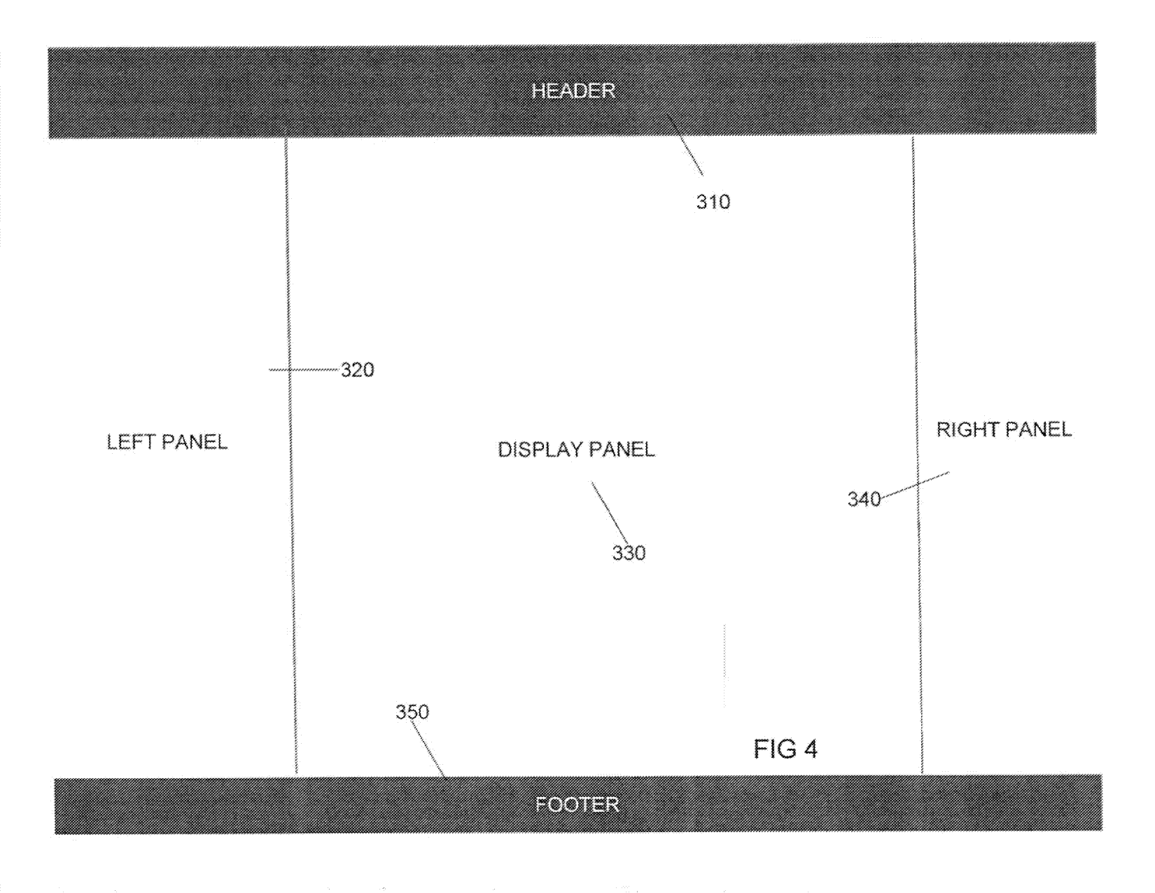

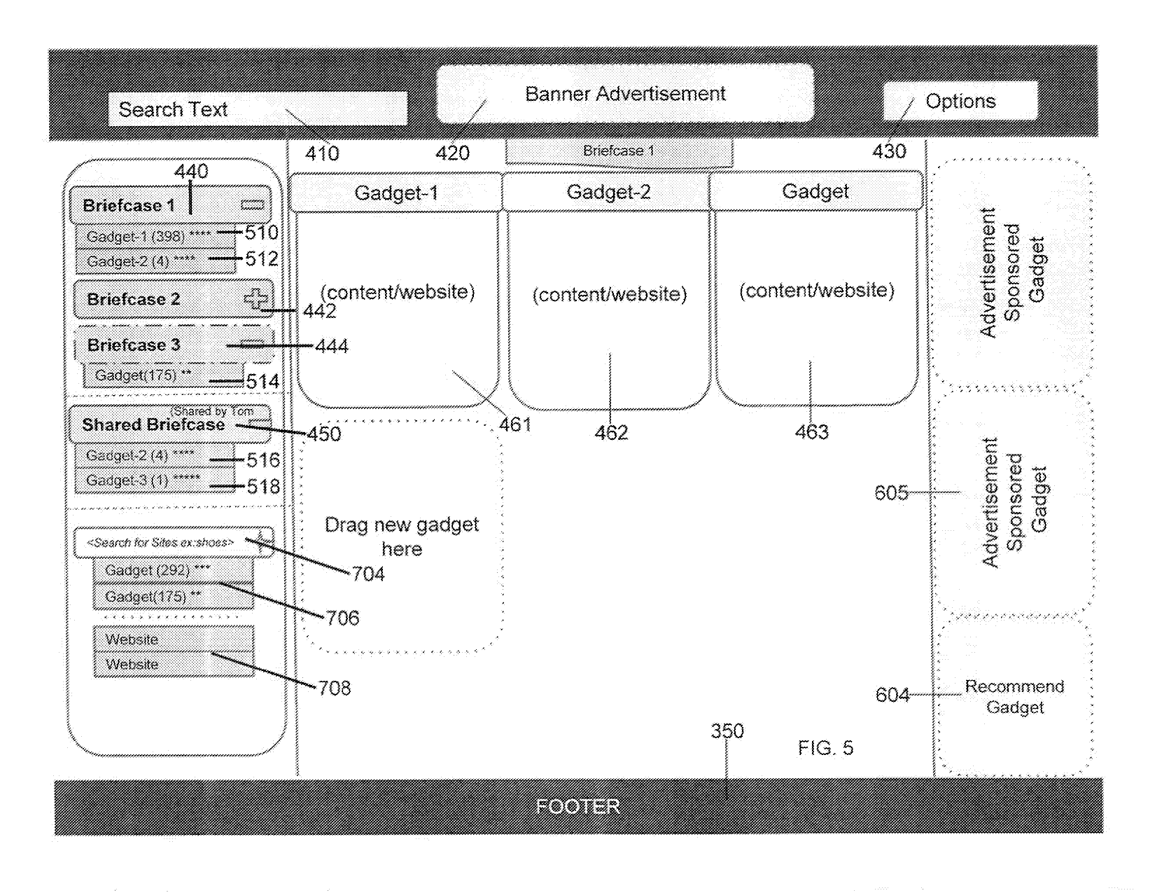

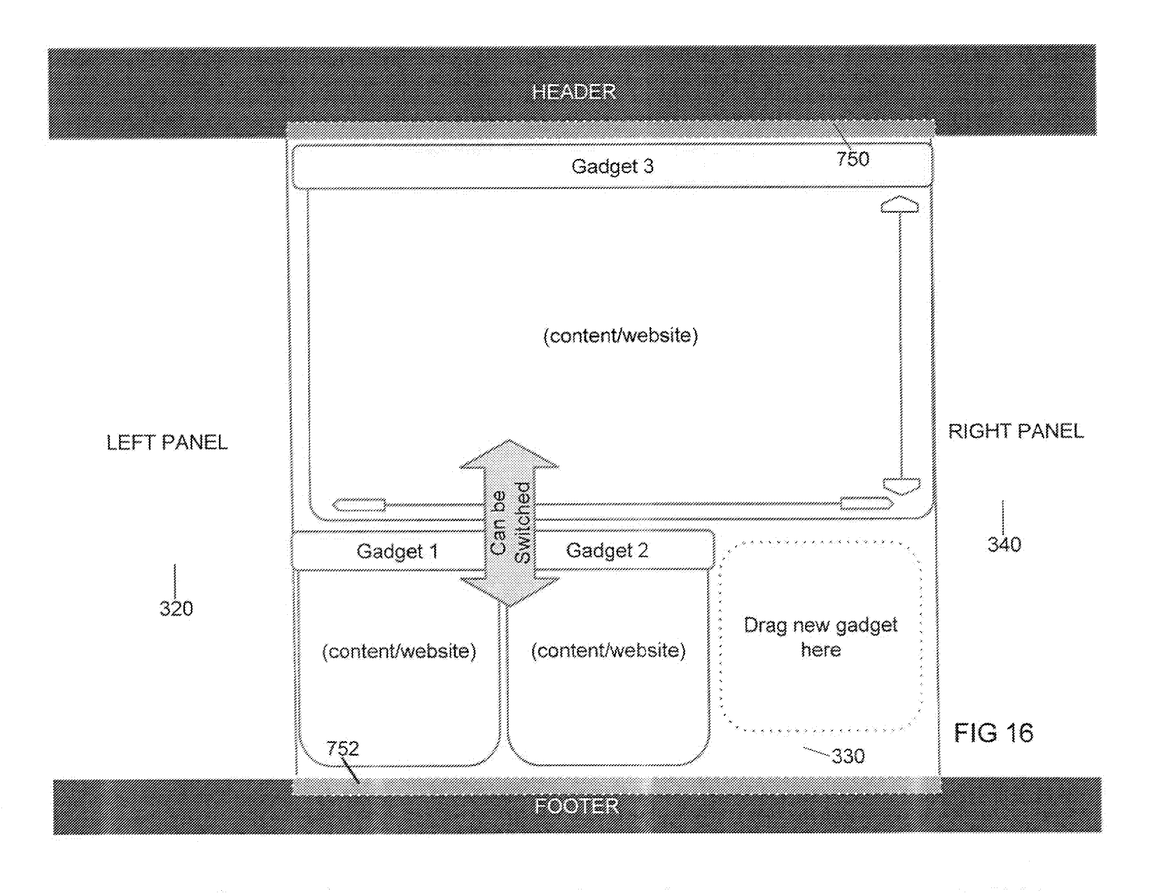

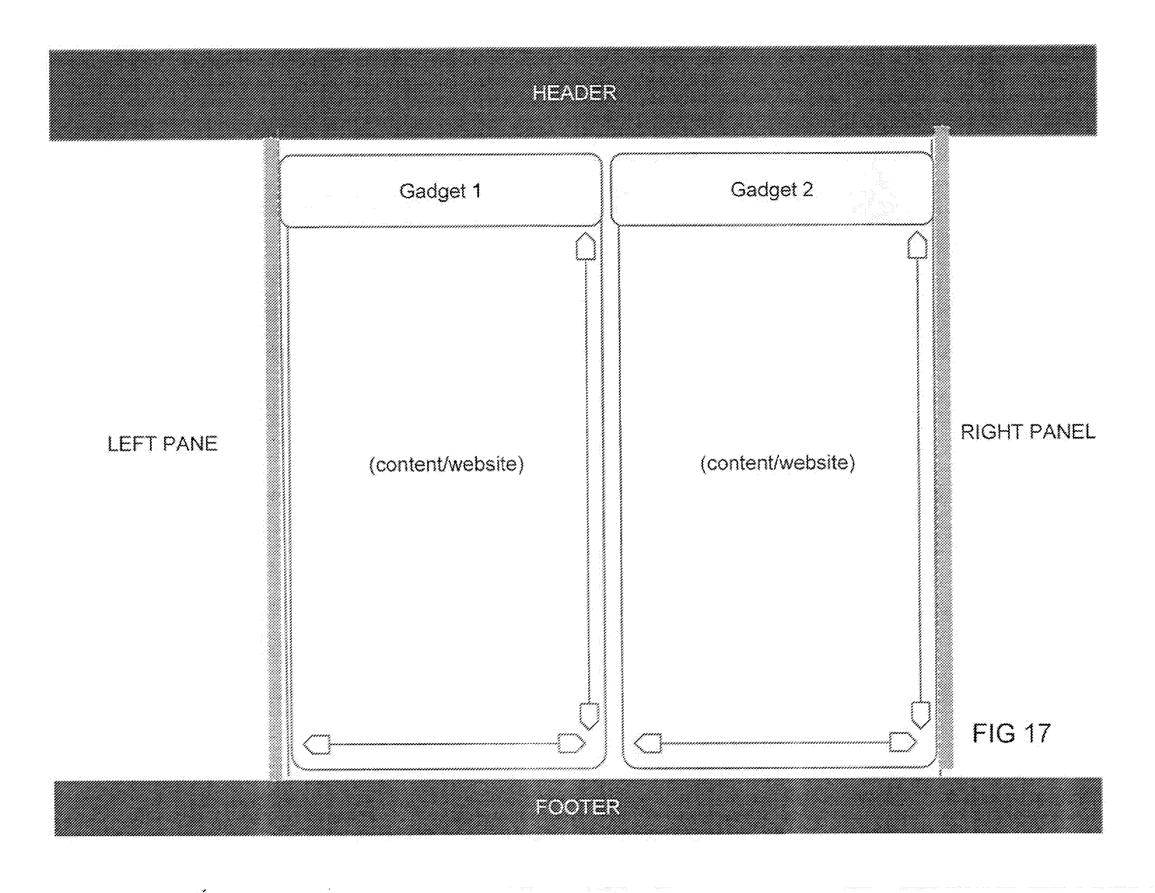

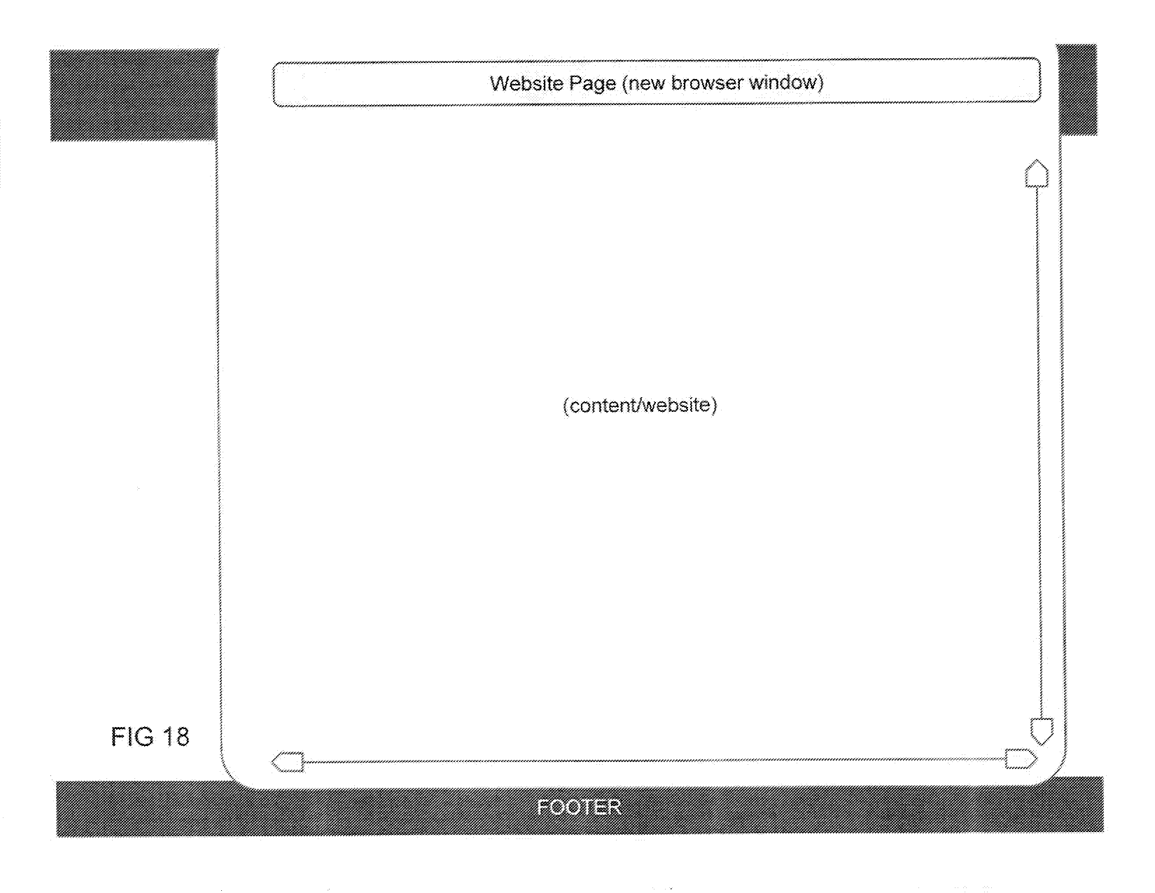

FIGS. 4 through 7, 9 through 13, and 16 through 17—are a series of screen shots depicting an example of a display according to the invention under a variety of conditions. In an exemplary embodiment, the display items are managed by the application controller (ie. Controller code 136) and the Presentation Code 134. In FIG. 4, a generic layout of a dynamic page (for displaying output to the user), displayed on a display device, the dynamic page generally comprises header 310, left panel 320, display panel 330, right panel 340, and footer panel 350. Note that this particular example of a dynamic page has proved effective in practice, but a variety of alternative layouts would also work effectively. FIG. 5 is a more specific example of an effective layout for a dynamic page. In FIG. 5, search controller 410 accepts keyword text and initiates searching based on the user's input.

In this exemplary embodiment, Display panel 330 displays three gadgets 461, 462, and 463. Gadgets are placed into the display panel 330 to be opened for display; the user may control this operation by dragging and dropping individual gadget items or briefcases (collections) of gadget items onto the display panel 330.

Referring to FIG. 2D, in this exemplary embodiment, upon entry of the search terms into search controller 410 via the user input device 106, the application controller 102 receives the search terms, determines the gadgets to be searched, formulates the search terms into a search query appropriate fir each gadget to be searched, and passes each search query to the corresponding gadget 462, 463 currently shown in the display while maintaining the gadgets layout on display panel 330.

Optionally, but preferably, the required request string and handling instructions for each gadget as it requests content from the underlying web site/web service are specific to a particular gadget and are used to provide an optimal display of the most useful portion of the resulting web page upon searching of a particular website using its corresponding gadget. For example, a gadget might search a commercial website and, upon receiving or search result, scroll the resulting web page down past headers and banners to the substantive search result.

Optionally keyword searches per by user are stored in a search history table in the data storage device 109.

Upon return of a search result from the website or other content source corresponding to each gadget, the device 100, and in particular the display device 104, shows a fully operable website or other display corresponding to the content located in the search in the corresponding gadget.

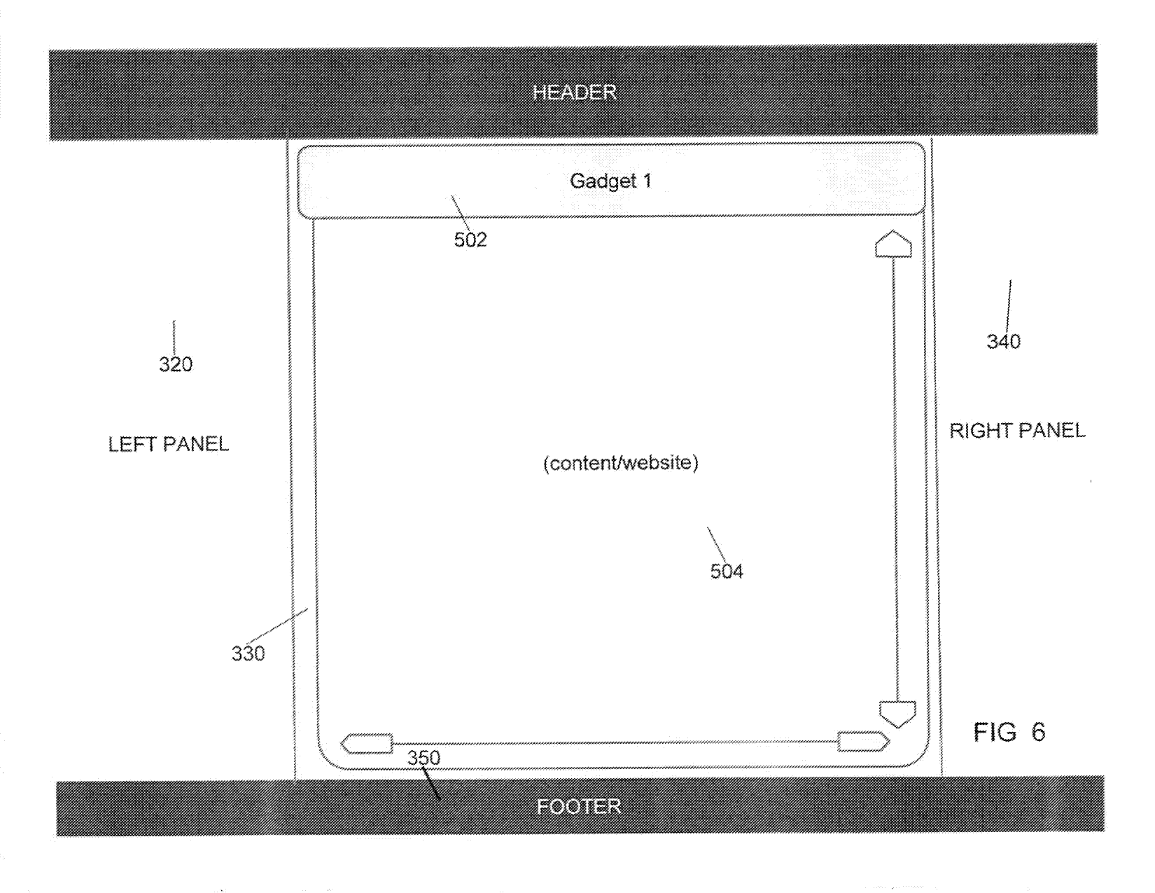

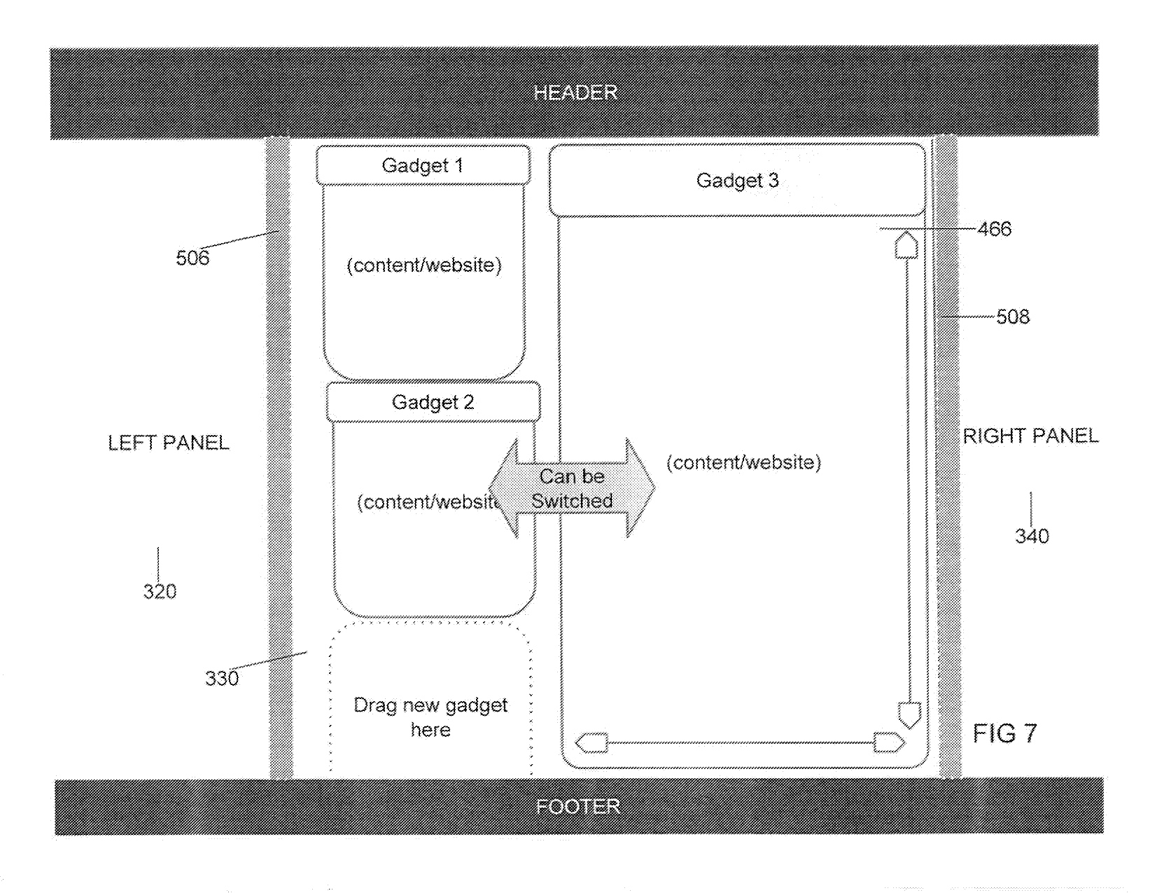

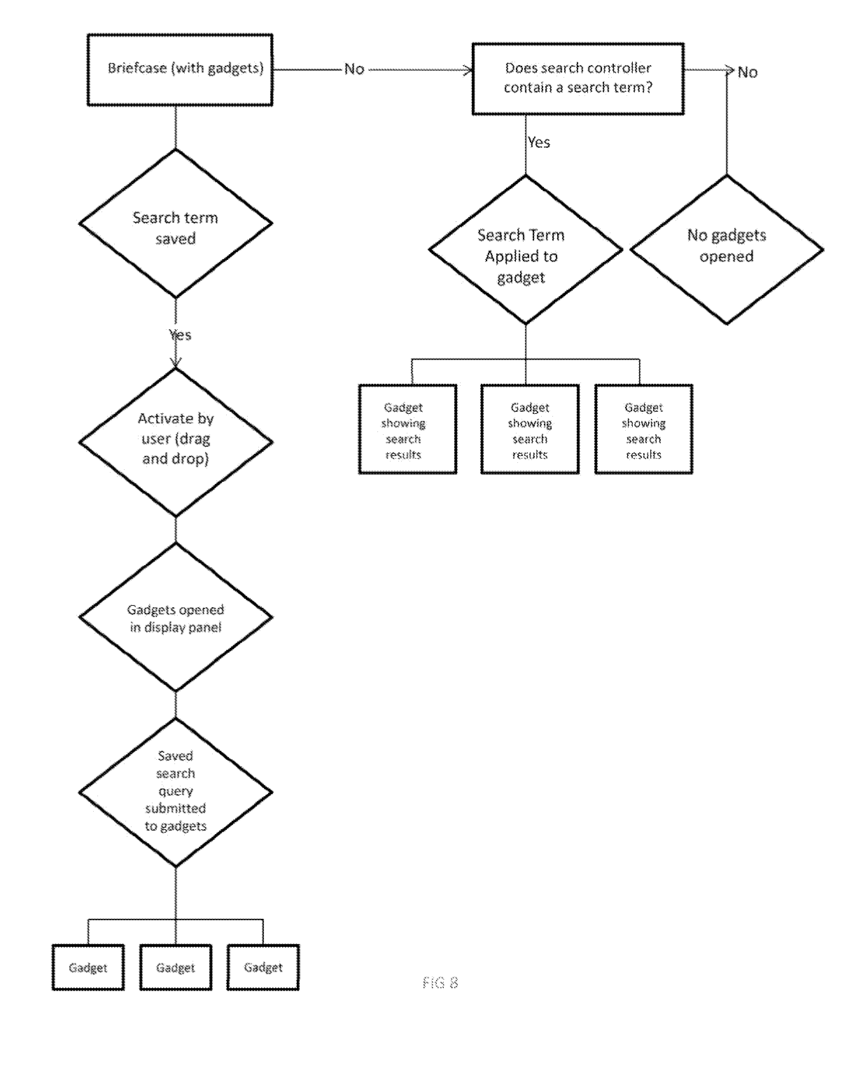

Optionally, as shown in FIG. 6, a gadget item may be expanded to take up the full available space of the display panel 330. In some embodiments, options are present on the title bar of each gadget 502, and website content is displayed in 504 with optional scroll bars. Optionally, as shown in FIG. 7, a collapsed gadget may be expanded to half the available horizontal space of the display panel 330 by dragging any collapsed gadget to the left-and-right expansion zones 506, 508. Dragging the gadget to the right expansion zone 508 will expand gadget to half of display screen on the right. Similarly dragging a gadget to the left expansion zone 506 will expand the gadget to take up half of the display screen on the left. Other gadgets that are still collapsed will reorganize to fill the available remaining space within the display panel 330. A half-expanded gadget 466 may be dragged and dropped to the opposing side (left or right) where automatic reorganization of the remaining condensed gadgets takes place. An option is available on an expanded gadget to collapse it. A gadget display optionally may include one or more of the following: owner comments, an owner's blog, user comments, user ratings, or icons that bring up a display of any one or more of these items.

Optionally the display may include banner advertisement 420 and options link 430, which operate in conventional fashion to provide banner advertisements and to initiate alteration of user configuration options such as user sign-in, user registration, design and theme of display, print options, sharing options, and consistent display options.

In some embodiments of the invention, the left panel area of the display shows a list of gadgets arranged in groups called briefcases (they may also be called “baskets” but will be referenced as “briefcases” in this document). Each briefcase holds a collection of names of or representations of or references to gadgets, and the briefcase may be activated by the user, for example, by dragging and dropping the briefcase on to the display panel, such that all gadgets in the briefcase are opened and added to the display panel. A briefcase optionally may be associated with one or more search terms that may be submitted to each gadget upon activation of the briefcase. Briefcases preferably may be named, copied, and shared via social media and email. A briefcase display optionally may include one or more of the following: owner comments, an owner's blog, user comments (which may be limited to subscribers), user ratings, or icons that bring up a display of any one or more of these items.

Preferably the system may, in response to user input, minimize a briefcase, share a briefcase, open a briefcase containing gadget items in the display, open gadget items and search each gadget using a saved search term, rename a briefcase, delete a briefcase, or, change the theme/color of a briefcase. Gadget options preferably include color/theme, gadget name, delete, minimize, maximize, open in new window, sharing, star rating, etc. A Gadget preferably can be shared with other users. Gadgets also preferably can be rated, and the rating is shared amongst users.

Optionally clicking on banner advertisement 420 will open a new gadget with content from the website of the banner sponsor.

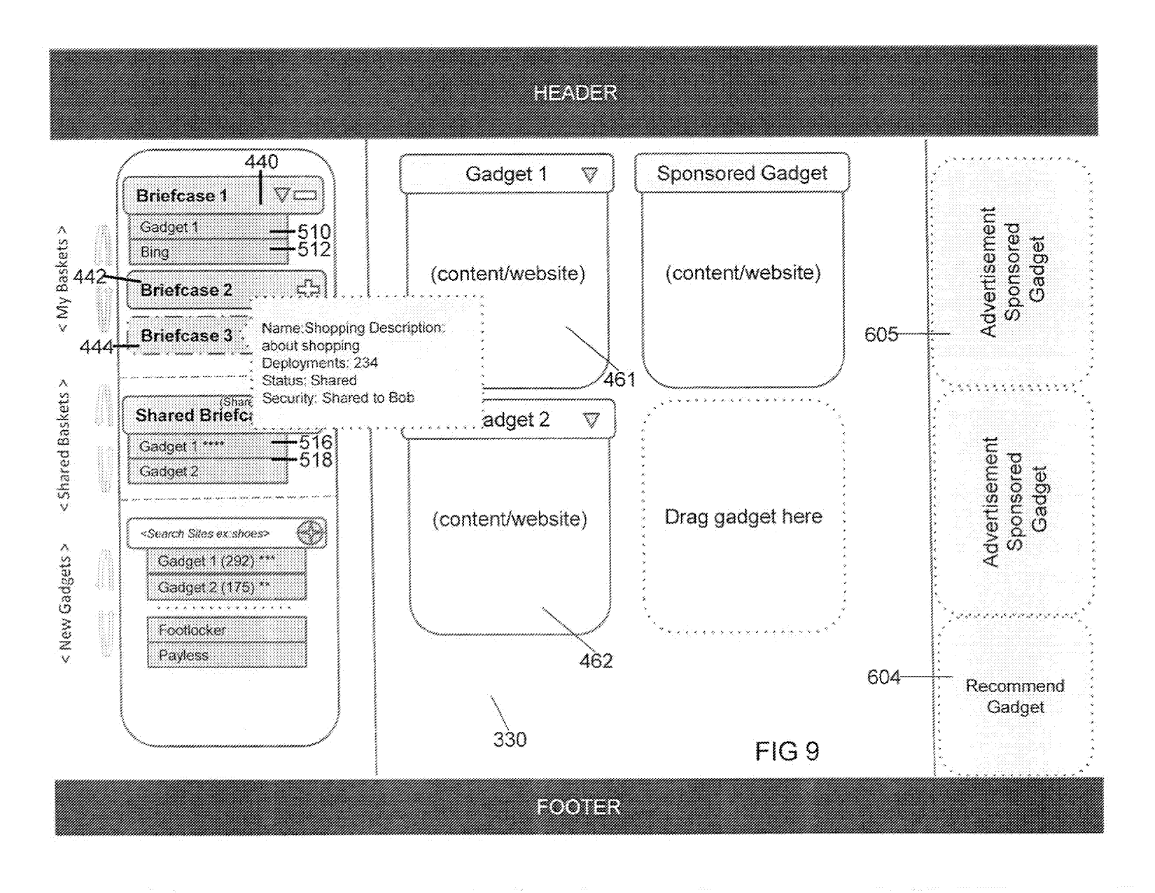

As shown in FIG. 9, briefcases and gadgets optionally may be navigated in a collapsible accordion-style display which, to conserve space on the display, can be rotated in a rolodex fashion. Animation and transition attributes of html objects (see DOM elements transitions5 and animations6) may be exploited to implement the interface for ease of use and optimized screen usage. Swiping the briefcases up or down will rotate the rolodex display, thereby displaying other briefcases that may be in the list but are hidden in the rolodex. Briefcases 440, 442, 444 can be clicked or dragged and dropped onto the display panel 330 to display and/or show the corresponding gadgets. All display gadget 462 will then open within the display panel 330 with a search, if one is saved with the briefcase, already executed on each display gadget. Gadget items 510, 512, 516, and 518 can also be individually clicked or drag-and-dropped or otherwise selected onto the display panel 330 to display the gadget with any associated search term already executed. A Displayed gadget 462 can be dragged from the display panel 330 into one of the allowed briefcases 440, 444 to be added to the briefcase as a new gadget item if not already present. Any search term that has been searched in the gadget at the time of the search may be saved with the gadget item. Preferably dragging-and-dropping any briefcase or any gadget item onto display panel 330 can automatically execute a keyword search on the gadget 462 before opening in the display panel. Optionally the system may permit a user to add a gadget to an exclusion list, which would prevent that gadget from appearing in any search results.

A briefcase optionally may allow control of “subscriber” gadgets by a “master” gadget within a collection. The application would allow an owner to specify a “master” type gadget and some “subscriber” type gadgets. The owner would then specify a list of parameters in the master gadget—for example, ‘text edit boxes’, ‘date control’, ‘numeric values’, ‘slider control’, etc. The owner would then map specified parameters in master gadget to url parameters of the subscriber gadgets—in other words, copying inputs from the master gadget into the appropriate fields or submission formats for the subscriber gadget. Any change made by application user to the parameters in the master gadget would trigger an update of the relevant subscriber gadgets that utilize those parameters.

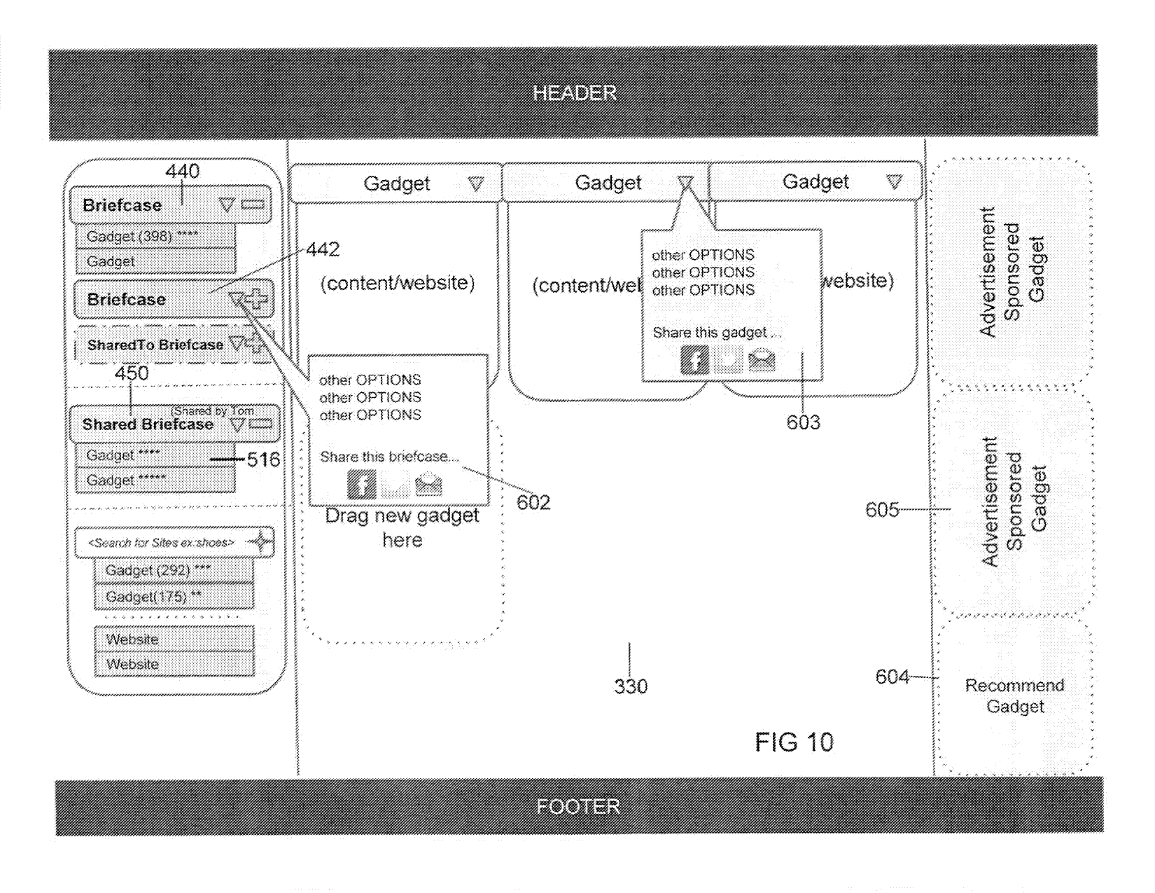

The system preferably permits the user to manage briefcases and related items in briefcases owned by the user. As shown in FIG. 10, optionally, the device permits the owner of a briefcase to “share out” the briefcase to other users. Sharing may be restricted to an approved set of users. A briefcase may be “shared out” or “shared to” other users by its owner; for the users who receive the briefcase, the briefcase will be a “shared in” briefcase that can be opened and used but not altered—in preferred embodiments, the power to alter a briefcase is reserved to its owner. Briefcases (including “shared in” briefcases) may be copied by the subscriber. The copy, which is owned by the subscriber, may be altered by its owner—but those alterations will not affect the original briefcase that was copied. A briefcase may be shared publicly, such that anyone may access the briefcase, or privately such that the briefcase may be accessed only by specified registered users of the system.

Referring to FIG. 10, sharing within the briefcase sharing options allows for this instance of the user briefcase to be shared with other users. The user sharing the briefcase to others is the “owner” of the briefcase and the briefcase may be depicted by highlighting or depiction as a shared-out briefcase 444. To facilitate sharing, a gadget may further comprise or have associated therewith an identifier. The contents of a briefcase may, on request by one user, be shared with one or more other users. Sharing may be accomplished by transmitting the identifier of the briefcase to one or more other users in response to user input. Sharing preferably uses email and other available social media actions 602, including but not limited to, posting, apparatus' briefcase links on user's Facebook page, as a tweet from user's Twitter account and/or other social media actions. Clicking on the link will allow recipient to operate the system on the recipient's display device and view the shared briefcase in the display panel 330. Any changes made by “owner” to the shared-out briefcase 444 may be automatically reflected in the shared-in briefcase 450 of the “subscriber”. For email, appropriate dialogs will open which will send an email to the intended subscriber and embed the link of the briefcase 444 in the email. A unique sharing ID preferably will be sent as part of the link to allow only approved recipient(5) access to the briefcase. A recipient of the email may click on the link to open the system on a display device where shared-in briefcase 450 is displayed. The shared-in briefcase 450 preferably is stored as a reference (and not copied or cloned) of the shared out briefcase 444 of the owner. Any changes made by owner to the shared-out briefcase will automatically reflect the changes in the recipient's shared-in briefcase. The system optionally may alert subscribers if the shared-out briefcase has been changed by its owner.

Optionally, gadget items may be placed into briefcases by entering its address in a form or via drag-and-drop. In certain embodiments, if the gadget item is copied into a shared-out briefcase, the gadget is also shared-out as by virtue of the parent briefcase being shared. Moving a gadget item into a shared-out briefcase 444 automatically shares the gadget to all downstream “subscriber” users of the shared briefcase. This new gadget item would appear in the shared-in briefcase 450 of the subscriber as shared gadget 516.

Gadget sharing options preferably allow an instance of a gadget to be shared with other users. Sharing a gadget may be accomplished using email and other available social media actions 603, including but not limit to posting on a Facebook page, as a tweet from a Twitter account and other social media actions including sending message on the Recommendation gadget 604 to other apparatus users. Clicking on the link will allow recipient to open the gadget and view it on the display device. A unique identifier will be sent as part of the link to allow only the approved recipient to see the gadget. Recipient of the email may click on the link to open the apparatus on their display devices where the shared gadget is displayed in the center panel 330. The shared gadget is stored as a reference (and not copied or cloned) on the apparatus of the recipient.

Briefcases are collections of gadget items 510, 512 and preferably are stored in the data storage device 109. Access to the list of briefcases and gadgets contained within them is managed by the application controller 132. The storage may be a SQL or noSQL database hosted natively by Apparatus infrastructure or in the cloud as a cloud database. (A cloud database is a database that typically runs on a cloud computing platform, such as PC backup, Amazon EC2, GoGrid and Rackspace). A user defined keyword search, which is used to run an automatic search on each gadget display 461, 462, 463 when the briefcase is dragged-and-dropped on the display panel 330, can be saved as part of or in association with a briefcase. The apparatus optionally will position the underlying website page content at the most relevant coordinates (x,y location of the page). In other words, the underlying page will be shifted (scrolled) so that the most relevant information, which is the substantive search result, is visible at the top and left of the gadget box, possibly skipping the left space and top space of the website.

On the left display 320, a briefcase appears as a list of gadget items. Each gadget appearing in the briefcase is a button representation of a display gadget 461, 462, 463.

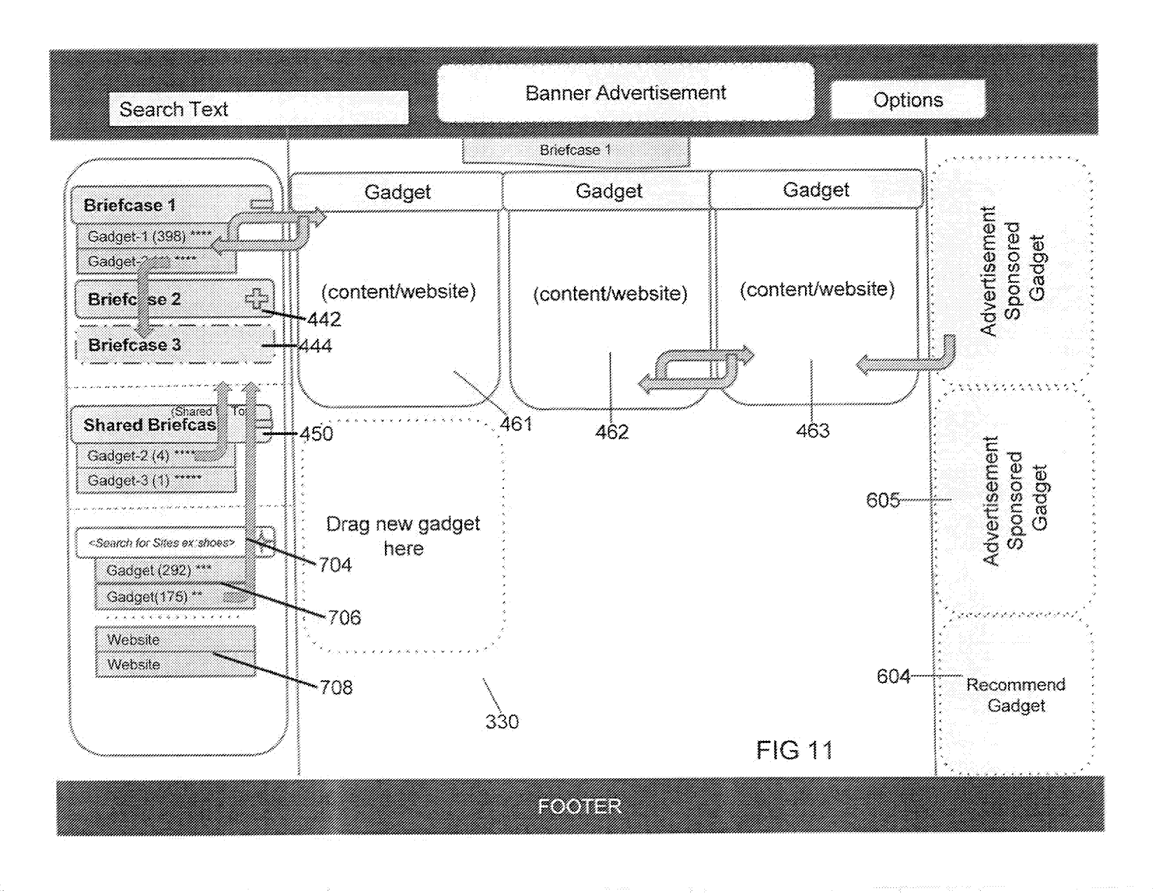

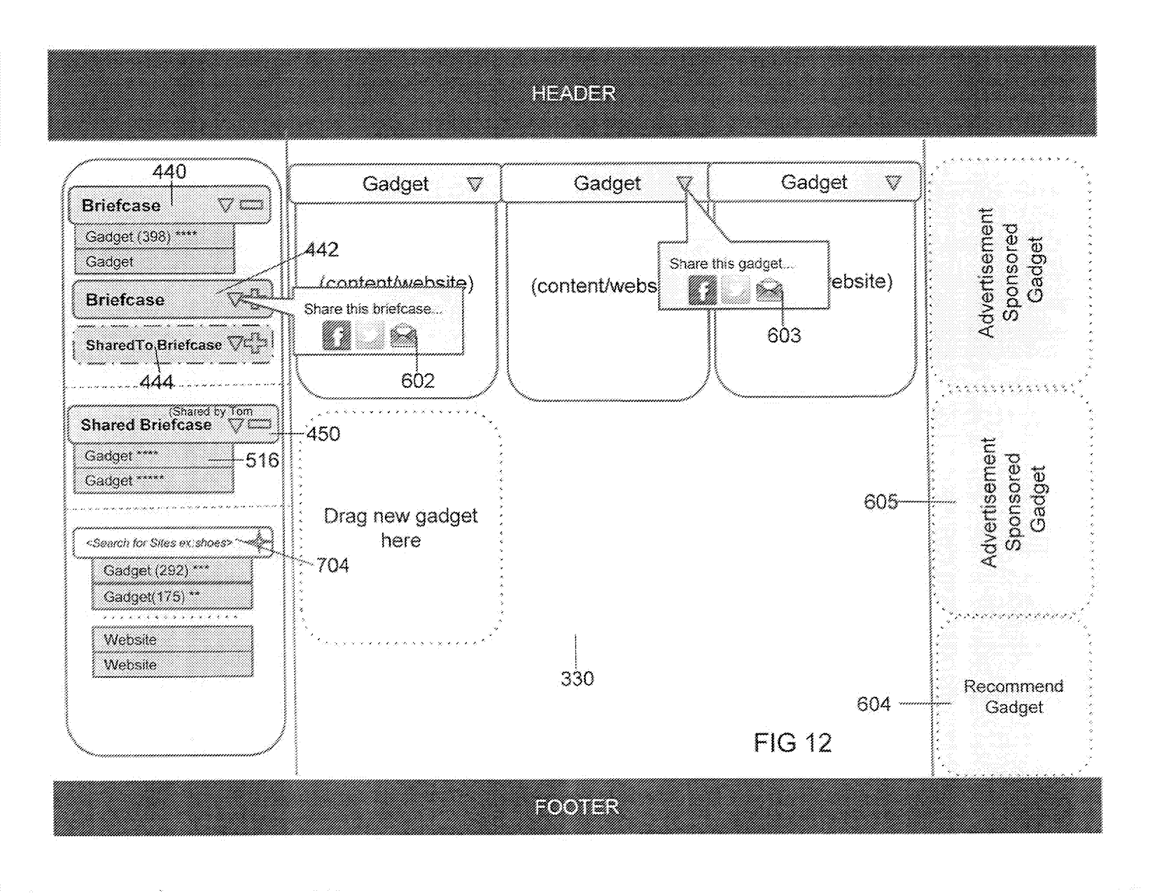

Gadget 462 is a display mechanism for content rendered as a window 462 on the display panel 330. Each gadget may optionally be tagged with keywords (or meta keywords) describing the content represented by the gadget; this information optionally may be stored in the data storage device 109. As shown in FIGS. 11 and 12, the gadget can be renamed by the user, sorted; moved around, shared and opened on the display panel to show content in a window form 461, 462, 463. Information about each gadget preferably is managed by the application controller and stored via the data storage device 109.

The system optionally provides a gadget discovery feature to aid the user in finding new gadgets or websites links (URLs) that can be adapted into gadgets and placed in a user briefcase. In one embodiment of a system including such a feature, search terms input by a user are passed to the application controller 102 and may optionally be stored via the data storage device 109. The application controller 102 then recommends additional gadgets to the user based on one or more of the following criteria: the search terms input by the user, the other gadgets that are currently opened as part of a briefcase, user profile information, and gadgets used by other users.

Further optionally, the system includes advertiser gadgets 605 that function in the same manner as described, above for gadgets generally, so that the advertiser gadget responds to search keywords entered into the search controller 410 by performing a corresponding search on the gadget location's web content. Optionally, advertising gadgets may be selected to be displayed based on criteria such as user search history and keyword purchases by advertisers.

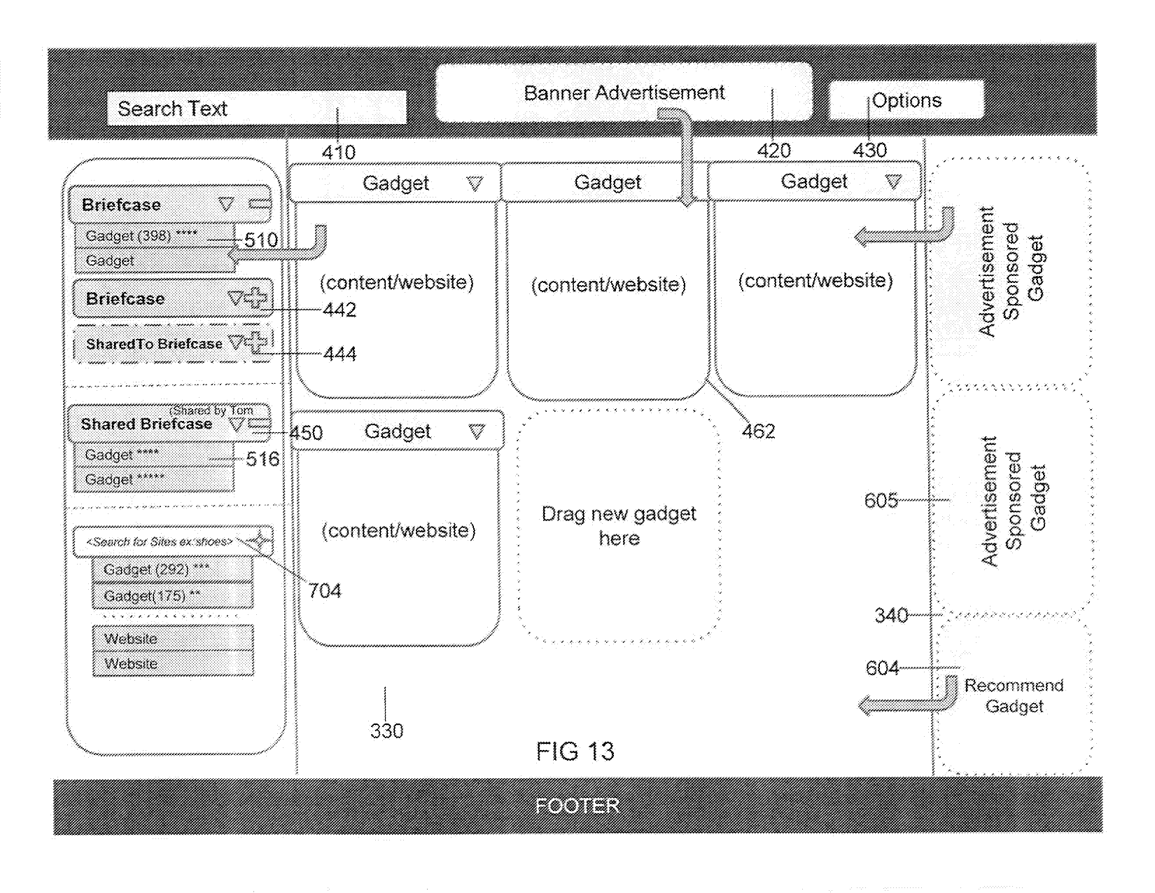

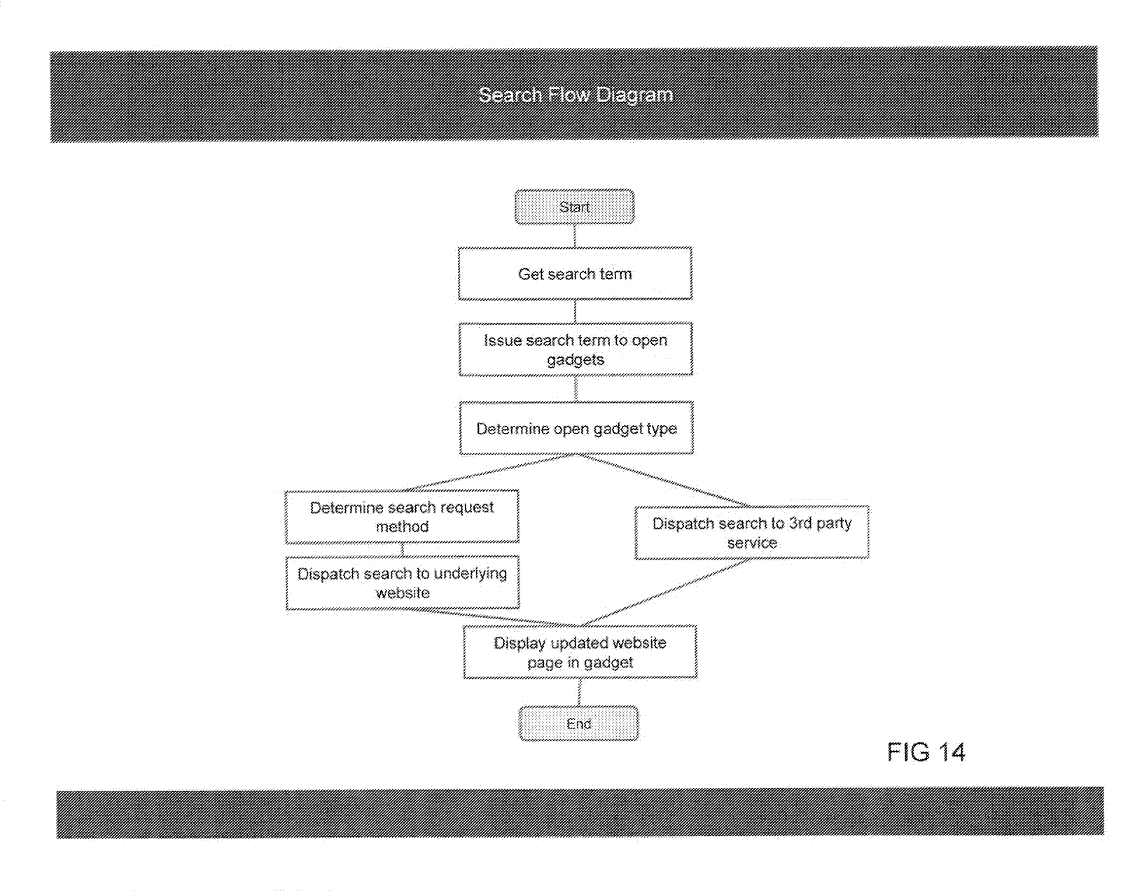

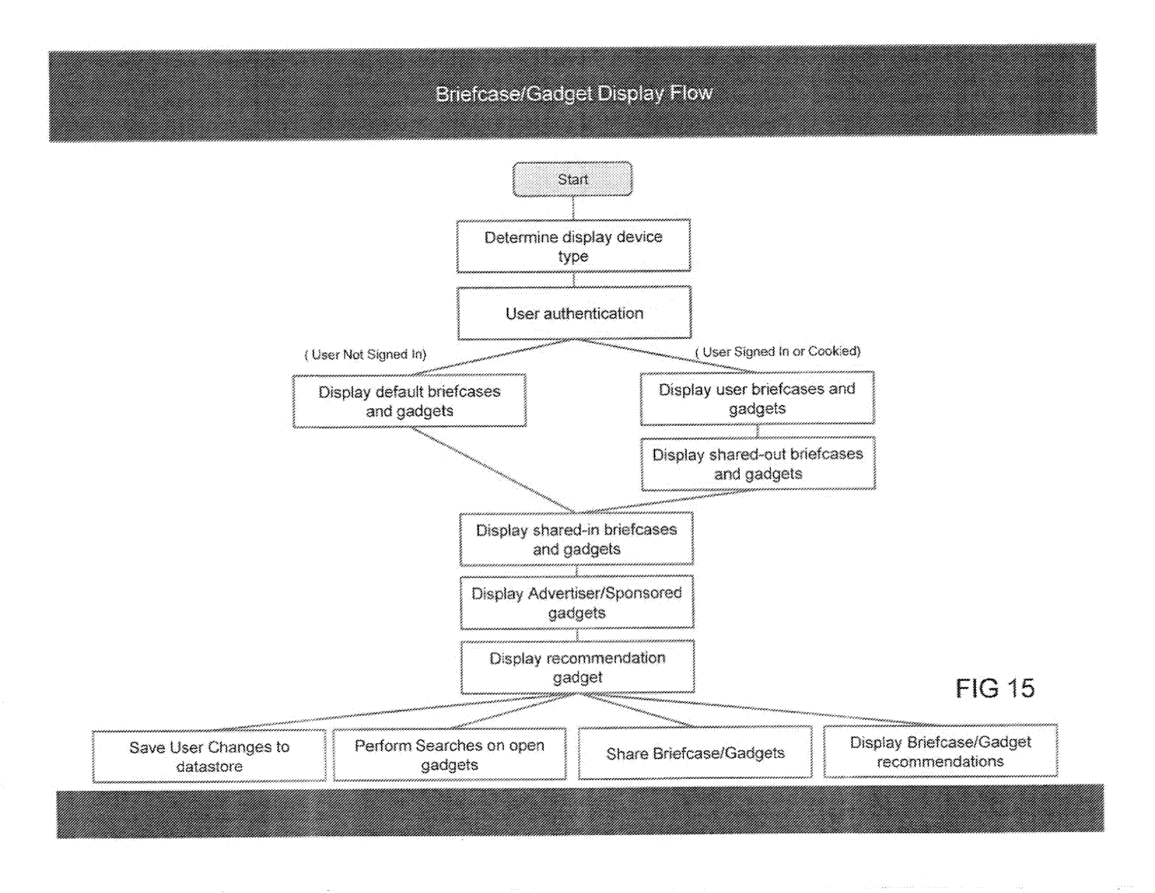

In the embodiment depicted in FIG. 13, an advertiser gadget 605 is positioned in the right panel 340 and displays website content from a sponsor or advertiser. The advertiser gadget 605 is chosen according to the apparatus business rules for display of sponsored content based on various criteria. The advertising gadget 605 displays content within the context of the user's search. To clarify, the advertising gadget will perform a search on the underlying advertiser web page for the user entered keyword in the search controller 410. The gadget 605 can be clicked to expand and preview content available via the advertising gadget, and returned back to right panel 340 by user click of the preview window. The gadget can be dragged-and-dropped into display panel 330 to join other gadgets 461, 462, 463 in the current open briefcase 440. The advertiser gadget 605 functions similar to standard gadgets 461, 462, 463 except that the selection of the web content site is controlled according to business rules of the apparatus. Business rules dictate which underlying sponsor/advertiser website is to be displayed inside the gadget 605. The criteria applied under the business rules may be the keywords supplied, other gadgets already open in the display panel, user profile information, selection of gadgets present in user briefcases, or other criteria.

In some embodiments, the advertiser gadget 605 performs an http request (via http GET or http POST) to the underlying web content resource with any search parameters populated consistently with the search terms in the search controller 410. The formatting (configuration) of the request string is preferably preset by the editorial work done by apparatus staff for each gadget. The response from the underlying website or other searchable content source is displayed within the window space of the gadget 605 on right panel 340. Display of the gadget window may be supported by the IFRAME element of the HTML5 standards. Optionally the system allows the user to add a sponsored/advertiser gadget to a briefcase (the briefcase, as noted above, is sharable). The use of gadgets to display sponsored/advertiser live web content, which is context sensitive to user entered keywords, is an advantage of certain embodiments of the system. Advertising based on actual search results from the advertiser's website is likely to be credible and useful to the user, and therefore likely to stimulate sales for advertisers.

[Advertiser and sponsored gadgets 604, 605 are sensitive to keywords used in the search term and present content from sources and searches chosen based (in part) on search terms entered by the user into the search controller 410. They are also sensitive to the other gadgets displayed in the open briefcase at the time. Optionally, a user may drag an advertiser gadget 605 to the display panel 330 and preview the underlying website in a maximized display and use options available to save the preview gadget to a briefcase. If an advertiser gadget 605 is saved to a shared-out briefcase 444, the advertiser gadget 605 automatically appears in the shared-in briefcase of all shared recipients (subscribers) of that briefcase. Banner advertisement 420 optionally may be dragged to the display panel 330 to preview the underlying content of a related website in a maximized display. Use options are available to save the preview gadget to a briefcase. If advertiser gadget 605 is saved to a shared-out briefcase 444, the advertiser gadget automatically appears in the shared-in briefcase 450 of all shared recipients (subscribers).

Recommendations displayed in the recommendation gadget 604 can be clicked or dragged onto the display panel 330 and previewed in a maximized display. In response to user input, the gadget may be saved to the shared-out briefcase. If the recommendation gadget is saved to a shared-out briefcase 444, the advertiser gadget automatically appears in the shared-in briefcase 450 of all shared recipients (subscribers).

The system further may recommend gadgets to the user based on various criteria such as search keywords entered into the search controller 410, history of keyword searches, user profile information, gadget display profile by the types/genre of gadgets currently in display panel 330, other users' briefcase profile based on gadget items in their briefcases that resemble/match display gadgets on current user's display.

The system may display text, icons, graphics, or other material indicating that particular portions of the display or search results are sponsored by a particular person.

The system optionally further allows searching of existing gadgets using search keywords entered by the user. The application controller initiates or performs a search of the gadget and/or briefcase databases for all gadgets items and briefcases that meet the keyword search. A gadget can also be copied 702 to a briefcase 440, 442 or shared-out briefcase 444 to share with other users. Searches may also be performed on a Search Engine (like Yahoo, Google, Bing or similar) to determine other web resources that match the search term entered in the search box 704. Apparatus performs a search on internal database of existing gadgets' tagged keywords and displays matches 708 in the left panel 340. The display of the gadgets is similar to other gadget items and handled by the apparatus' presentation code 134. The system also may perform a search via a search engine for the keywords in the search box 704 and shows a list of relevant web search results depicted as gadget items 706 to aid the user in finding (if needed) resources for which a standard resource does not exist. Search results are filtered against already existing Gadgets in the apparatus database to show only new resources of the search-engine search that are not present in the apparatus datastore of Gadget Items. A user who finds a new resource of interest may request creation of a searchable gadget corresponding to that resource.

Optionally the system maintains a list of gadget items already present in the apparatus datastore. This list may show the number of gadget deployments on all other briefcases of all users; as well as an average star rating for each gadget to allow more information selection of gadgets. A search is performed on the apparatus datastore 132 for the full complement of gadget items by looking at their name, tagged descriptions and underlying web resource's keywords and descriptions. Matching gadget items are listed on left panel 340 by the presentation code 134. Finally, the device display optionally includes a footer 350 with copyright, status, or other application information, operating by industry standard implementation.

In FIG. 1, the user interface application (“UI”) is part of the apparatus which runs on the user client device. The Client Device 100 is any electronic display device such as a Smartphone, Tablet, Laptop PC or a desktop PC. The UI user interface application receives its data from a combination of cache storage 128 or a data storage device which may take the form of a backend datastore service on one or more web servers 130 via the network connection 112, which may be over the internet. Web servers 130 expose application services 132 to service the requests from the user interface application 126 over the network/internet 112. Application Services 132 fetch, update and store data in the data storage device 134. The user interface application, having received required information, updates the gadget displays with web content from websites 120, 122, 124. The user interface application running on the client device may follow a variant of the MVC (model-view-controller) design

Claimed is:

1. A system, comprising:
a display device;
a user input device;
a data storage device;
an application controller in operative communication with the display device, the user input device, and the data storage device;
a plurality of gadgets, each gadget comprising a search device that searches and displays the result of a search of a web based content source by receiving a search query, submitting the search query to a search mechanism adapted to search the web based content source, receiving the result of the search of the web based content source, and displaying the result of the search of the web based content source in an operative window;
wherein the system accepts input in the form of a search term from a user via the user input device and passes the search term to the application controller, and
wherein the application controller determines which gadgets are to be searched, formulates the search term into a search query appropriate for each gadget to be searched, and passes each search query to its corresponding gadget for searching and display of the results.

2. A system according to claim 1, wherein each gadget returns the search result in an operative window that has been scrolled to a targeted portion of the result of the search of the web based content source.

3. A system according to claim 1, wherein the function of determining the gadgets to be searched comprises determining the gadgets that are currently displayed.

4. A system according to claim 1, wherein the function of determining the gadgets to be searched comprises determining the gadgets contained in a particular briefcase.

5. A system according to claim 1, further comprising a search controller that is displayed on the display device, that accepts a search term via the user input device, and that submits the search term to the application controller, which in turn updates gadget currently displayed on the display by determining which gadgets are to be searched, formulating the search term into a search query appropriate for each gadget to be searched, and passing each search query to its corresponding gadget for searching and display of the results.

6. A system for creating a dynamic page of results of searches performed on multiple web based content sources, based on the input of a search term to be searched in each of the multiple web based content sources, comprising:
a page displaying a plurality of gadgets selectable by the user, each gadget comprising a search device that searches and displays the result of a search of a web based content source by receiving a search term, submitting the search term to a search mechanism adapted to the web based content source, receiving the result of the search of the web based content source, and displaying the result of the search of the web based content source in an operative window;
a gadget selector that accepts, via the user input device, a user's selections of gadgets to be included in the dynamic display;
a dynamic display processor that maintains a display including each gadget selected;
a search controller that accepts a search query,
and an application controller that receives a search term from the search controller, formats the search term into a search query corresponding to each gadget, and submits the corresponding search query to each gadget.

7. A system according to claim 6, wherein device, in response to input from a user input device, can create and store briefcases of gadgets.

8. A system according to claim 7, wherein a briefcase of gadgets may have stored in connection therewith one or more search terms that, upon activation of the briefcase, is submitted to at least one gadget in the briefcase.

9. A system according to claim 6, wherein a gadget may be added to the existing dynamic page after a search term has been submitted to the gadgets on that page, and wherein that search term is submitted to the added gadget upon its addition to the dynamic page.

10. A system according to claim 6, wherein search terms input by the user are passed to the application controller and wherein the application controller recommends additional gadgets based on one or more of the following criteria: the search terms input by the user, the other gadgets that are currently opened in the briefcase, user profile information, and gadgets used by other users.

11. A system according to claim 1, further comprising an identifier associated with each gadget wherein a user may identify a gadget to another user by communicating said identifier.

12. A system according to claim 6, wherein each briefcase further comprises an identifier associated therewith and wherein the contents of a briefcase may, upon a request by a user, be shared with one or more additional users.

13. A system according to claim 12, wherein the application controller shares a briefcase by transmitting a briefcase identifier link.

14. A system according to claim 6, wherein said application controller causes the dynamic page to display a solicitation of a rating from a user, wherein the user input device accepts a rating from a user, and wherein the data storage device store a rating from a user.

15. A method for delivering an advertisement, comprising:
Obtaining from a user's search device information about the user's activity;
deriving, from the user's activity, a search term of interest to the user;
searching for the search term of interest and displaying the result of the search using a system comprising:
a display device;
a user input device;
a data storage device;
an application controller in operative communication with the display device, the user input device, and the data storage device;
a plurality of gadgets, each gadget comprising a search device that searches and displays the result of a search of a web based content source by receiving a search query, submitting the search query to a search mechanism adapted to search the web based content source, receiving the result of the search of the web based content source, and displaying the result of the search of the web based content source in an operative window;
wherein the system accepts input in the form of a search term from a user via the user input device and passes the search term to the application controller, and
wherein the application controller determines which gadgets are to be searched, formulates the search term into a search query appropriate for each gadget to be searched, and passes each search query to its corresponding gadget for searching and display of the results.

16. A method for delivering an advertisement, comprising:
Obtaining from a user's search device information about the user's activity;
deriving, from the user's activity, a search term of interest to the user;
displaying content from a web based content source in an operative window.
